(19) United States
(12) Patent Application Publication
(10) Pub. No.: US 2008/0221822 A1
(43) Pub. Date: Sep. 11, 2008

(54) System and Method for Calibration of a Flow Device

(76) Inventors: Marc Laverdiere, Wakefield, MA (US); Robert F. Mcloughlin, Pelham, NH (US); J. Karl Niermeyer, Tyngsboro, MA (US)

Correspondence Address: Katharina W Schuster;Sprinkle IP Law Group, 1301 W 25th St Suite 408, Austin, TX, 78705, US

(21) Appl. No.: 11/659,710

(22) PCT Filed: Aug. 12, 2005
(86) PCT No.: PCT/US2005/028741

§ 371 Date: Aug. 17, 2007

Related U.S. Application Data
(60) Provisional application No. 60/601,424, filed on Aug. 13, 2004.

(51) Int. Cl. G01F 25/00

(52) U.S. Cl. 702/100

(57) ABSTRACT

Embodiments of the present invention provide a system and method for rapid calibration of a flow device. A flow device can be provided with a calibration flow curve (e.g., represented by an n^{th} degree polynomial) by the manufacturer or a third party. The calibration curve can be adjusted for a process fluid and the system for which the flow device is actually installed using one or more correction factors. The correction factors can be determined for the flow curve based on a simple empirical test or fluid properties of the process fluid. The corrected flow curve is then saved at the flow device so that it can be used for future flow control.

### RELATED APPLICATIONS

This application claims, under 35 U.S.C 119(e), benefit of and priority to U.S. Provisional Patent Application No. 60/601,424, entitled “System and Method for Calibration of a Flow Device,” by Lavardiere et al., filed Aug. 13, 2004, which is hereby fully incorporated by reference herein.

### TECHNICAL FIELD

The present invention is related to calibration of flow devices and, more particularly, to the rapid calibration of mass flow meters and mass flow controllers.

### BACKGROUND

Flow controllers are used in a variety of industries to control the flow rate of liquids and gasses. One industry that relies heavily on flow controllers is the semiconductor manufacturing industry. This is because the manufacture of semiconductors requires accurate control of gasses and fluids being dispensed in a flow chamber. Many current flow controllers control flow on a differential pressure basis. These flow controllers receive a set point from a semiconductor manufacturing tool or other system, measure the differential pressure across a restriction in the fluid flow path and execute a control algorithm to open or close a valve based on the difference between the set point and the differential pressure.

Typically flow controllers receive a set point in terms of a mass or volumetric flow rate. The mass or volumetric flow rate is then converted to a pressure differential based on a calibration curve. The flow controller must, therefore, have a calibration curve stored for the process fluid and process conditions under which the flow controller operates. For a flow controller suitable for use with a variety of fluids and under various operating conditions, the flow controller manufacturer must typically either provide a large number of calibration curves for the flow controller or individually calibrate the flow controller for the process fluid and conditions under which it will operate. This can be a time consuming and inefficient task. Therefore, a need exists for a more expeditious system and method of calibrating flow controllers.

### SUMMARY OF THE INVENTION

Embodiments of the present invention provide a system and method for rapid calibration of a flow device that eliminate, or at least substantially reduce, the shortcomings of prior art systems and methods for flow device calibration.

A flow device can be provided with a calibration flow curve (e.g., represented by an n^{th} degree polynomial) by the manufacturer or a third party. The calibration curve can be adjusted for a process fluid and the system for which the flow device is actually installed using one or more correction factors. The correction factors can be determined for the flow curve based on a simple empirical test or fluid properties of the process fluid. The corrected flow curve is then saved at the flow device so that it can be used for future flow control.

One embodiment of the present invention includes a method for calibrating a flow device that includes producing a flow of fluid through the flow device so that a variable indicative of a flow rate of the fluid has a test value. This can include, for example, producing a flow so that a pressure differential, time differential, pressure at a particular sensor or other factor indicative of the flow rate of the fluid has a test value or multiple test values or set of test values. For example, a test value can be half of an expected maximum value. The method further includes determining an empirical flow rate of the fluid for a test period of time and applying a calibration curve to the empirical flow rate to determine a calculated value for the flow rate variable. The correction factor can be determined based on the test value and calculated value.

Another embodiment can include a computer program product comprising a set of computer instructions stored on a computer readable medium. The set of instructions can comprise instructions executable to determine a test value or set of test values of a variable or variables indicative of a flow rate, determine one or more calculated values for the variable(s) indicative of flow rate based on one or more empirical flow rates and an nth degree polynomial corresponding to a calibration curve and determine one or more correction factor(s) based on the calculated value(s) and test value(s) for the variable(s) indicative of flow rate. It should be noted that computer instructions can be executed by the controller of a flow device and/or a calibration computer in communication with the flow device or other computing device.

Yet another embodiment of the present invention includes a flow device comprising, a flow path, an upstream pressure sensor upstream of a flow restriction in the flow path, a downstream pressure sensor downstream of the flow restriction in the flow path and a controller coupled to the upstream pressure sensor and the downstream pressure sensor to receive pressure measurements from the upstream and downstream pressure sensor. The control is configured to cause a valve to open for one or more test periods of time to produce a flow of fluid through the flow device to generate one or more test pressure differentials between the upstream pressure sensor and downstream pressure sensor, determine one or more calculated pressure differentials based on an empirical flow rate and an n^{th} degree polynomial corresponding to a calibration flow curve and generate one or more correction factors based on the calculated pressure differential(s) and the test pressure differential(s). The controller can also be configured to cause the controller to open for several test periods of time to generate a set of test pressure differentials at the same set point or multiple set points to improve the accuracy of a particular correction factor or generate several correction factors.

Another embodiment of the present invention includes a method for calibrating a flow device comprising, loading a set of coefficients for an n^{th} degree polynomial corresponding to a calibration curve for a calibration fluid, correcting the coefficients of the set of coefficients based on the viscosity of a process fluid to generate a corrected n^{th} degree polynomial for the process fluid, storing the corrected coefficients in a memory location.

Another embodiment of the present invention includes a computer program product for calibrating a flow device comprising a set of computer instructions stored on a computer readable medium. The set of instructions comprise instructions executable by a processor to load a set of coefficients for an n^{th} degree polynomial corresponding to a calibration curve, load a set of viscosity correlation variables, receive an input indicating a viscosity of a process fluid, correct the set of coefficients based on the set of viscosity correlation variables and store a set of corrected coefficients.

Yet another embodiment of the present invention includes a flow device having a controller comprising a computer readable medium storing a calibration program and a processor to access and execute the calibration program. The controller is operable to load a set of coefficients for an n^{th} degree polynomial corresponding to a calibration curve for a calibration fluid and correct the coefficients of the set of coefficients based on the viscosity of a process fluid to generate a set of corrected coefficients for a corrected n^{th} degree polynomial for the process fluid and store the corrected coefficients in a memory location.

Another embodiment of the present invention includes a method of calibrating a flow device comprising producing a flow of fluid through the flow device so that a variable indicative of a flow rate of the fluid has a set of test values, determining an empirical flow rate for each test value of the set of test values, determining a set of coefficients for an n^{th} degree polynomial using the set of test values and empirical flow rates.

Another embodiment of the present invention can include a computer program product comprising a set of computer instructions stored on a computer readable medium, the set of computer instructions comprising instructions executable to: cause a flow device to produce a flow of fluid through the flow device so that a variable indicative of a flow rate of the fluid has a set of test values, determine an empirical flow rate for each test value of the set of test values and determine a set of coefficients for an n^{th} degree polynomial using the set of test values and empirical flow rates.

Yet another embodiment of the present invention includes a flow device comprising a flow path, an upstream pressure sensor upstream of a flow restriction in the flow path, a downstream pressure sensor downstream of the flow restriction in the flow path and a controller coupled to the upstream pressure sensor and the downstream pressure sensor to receive pressure measurements from the upstream and downstream pressure sensor. The controller is operable to cause a valve to open for a set of test periods of time to produce a flow of fluid through the flow device to generate a set of test pressure differentials between the upstream pressure sensor and downstream pressure sensor, determine an empirical flow rate for each test pressure differential and determine a set of coefficients for an n^{th} degree polynomial using the set of test pressure differentials and empirical flow rates.

### BRIEF DESCRIPTION OF THE FIGURES

A more complete understanding of the present invention and the advantages thereof may be acquired by referring to the following description, taken in conjunction with the accompanying drawings in which like reference numbers indicate like features and wherein:

FIG. 1 is a diagrammatic representation of one embodiment of a flow control device;

FIG. 2 is a diagrammatic representation of another embodiment of a flow control device;

FIG. 3 is a diagrammatic representation of a controller;

FIG. 4 is a flow chart illustrating one embodiment of controlling flow;

FIG. 5 is a diagrammatic representation of one embodiment of a system for calibrating a flow control device;

FIG. 6 is a flow chart illustrating one embodiment of calibrating a flow control device;

FIGS. 7A-D are embodiments of screens for interfacing with a calibration program;

FIG. 8 is a table of example data for deionized water (“DIW”), N1, IPA, S3 and S6 of pressure differential versus flow rate;

FIG. 9 illustrates a plot and line fit of a first coefficient versus kinematic viscosity for a particular flow controller;

FIG. 10 illustrates a plot of a second coefficient versus the square root of kinematic viscosity for a particular flow controller;

FIG. 11 illustrates a plot and line fit of a first coefficient versus dynamic viscosity;

FIG. 12 illustrates a plot of a second coefficient versus the square root of dynamic viscosity;

FIG. 13 is flow chart illustrating one embodiment of a method for calibrating a flow device for a particular process fluid; and

FIG. 14 is a flow chart illustrating another method for rapid calibration of a flow device.

### DETAILED DESCRIPTION

Preferred embodiments of the invention are illustrated in the FIGURES, like numerals being used to refer to like and corresponding parts of the various drawings.

Flow devices, such as flow meters and flow controllers, typically include a microprocessor based controller that processes readings from one or more sensors to determine the flow rate of a fluid through the device. The controller will apply a flow curve to some variable indicative of flow (e.g., pressure differential, pressure, temperature differential, etc.), usually in the form of an n^{th} degree polynomial, to determine the flow rate. To ensure that the measured flow rate is accurate, the flow curve must account for the process fluid being used and the system in which the flow device is installed.

Prior to the present invention, either the flow device manufacturer would have to develop a flow curve for the intended process fluid using a test rig similar to the system in which flow device was to be installed, or the customer would have to install the flow device and run tests to develop the curve. In either case, developing the flow curve for a particular fluid and system set up involved taking multiple sets of data and applying curve fitting algorithms to the data to develop the nth degree polynomial. This is inefficient as a new flow curve must be developed for each installation of a flow control device.

The present invention provides a system of rapidly calibrating flow devices. According to one embodiment of the present invention, a calibration curve can be established for the flow controller by, for example, the manufacturer of the flow controller using test conditions that can be dissimilar from the actual installation conditions. The calibration flow curve can be adjusted for the process fluid and system based on one or more correction factors, as discussed below.

According to one embodiment, the flow controller can be installed in the system in which it will operate and a correction factor for the calibration curve can be calculated based on empirical data from a small number of tests. The correction factor adjusts the calibration curve to account for differences between the test fluid and calibration system used to generate the calibration curve and the process fluid and process system in which the flow controller actually operates.

According to another embodiment, a set of correction factors based on the kinematic viscosity (or dynamic viscosity and density or just dynamic viscosity) can be applied to the coefficients of the n^{th} degree polynomial. This allows for quick calibration of the flow device for a particular process fluid based on the input of process fluid properties.

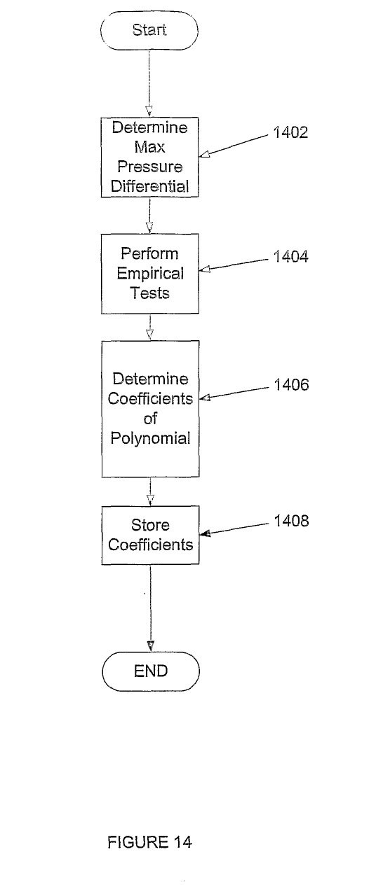

According to another embodiment of the present invention, a second order polynomial can be used to characterize the flow curve independently of a manufacturing flow curve. In this embodiment, the flow curve can be derived from a small number of empirical tests. A flow device can be configured to produce a flow of fluid at various flow rates. The empirical flow rates can be determined by measuring the fluid dispensed at each flow rate in a given period of time. Using the empirical flow rates, the coefficients of the second order polynomial characterizing the flow curve can be determined, as discussed in conjunction with FIG. 14.

Embodiments of the present invention can be utilized in the calibration of a variety of flow control devices including those described in described in PCT application PCT/US03/22579, entitled “Liquid Flow Controller and Precision Dispense Apparatus and System,” (the “Liquid Flow Controller Application”) filed Jul. 18, 2003, which claims priority of Provisional Application Ser. No. 60/397,053 filed Jul. 19, 2002, entitled “Liquid Flow Controller and Precision Dispense Apparatus and System” and is related to U.S. Pat. No. 6,348,098, entitled “Flow Controller,” filed Jan. 20, 2000 and Provisional Application Ser. No. 60/397,162, entitled “Fluid Flow Measuring and Proportional Fluid Flow Control Device”, filed Jul. 19, 2002, each of which is fully incorporated by reference herein. Other example flow control devices can be found in U.S. patent application Ser. No. 10/777,300, entitled “System and Method for Flow Monitoring and Control,” by Brodeur, filed Feb. 12, 2004, and U.S. patent application Ser. No. 10/779,009, entitled “System and Method for Controlling Fluid Flow,” by Laverdiere, filed Feb. 13, 2004, each of which is fully incorporated by reference herein. Exemplary flow controllers in which embodiments of the present invention can be implemented include the SINGLESENSE, OPTICHEM P and OPTICHEM C flow controller manufactured by Mykrolis, Inc. of Billerica, Mass.

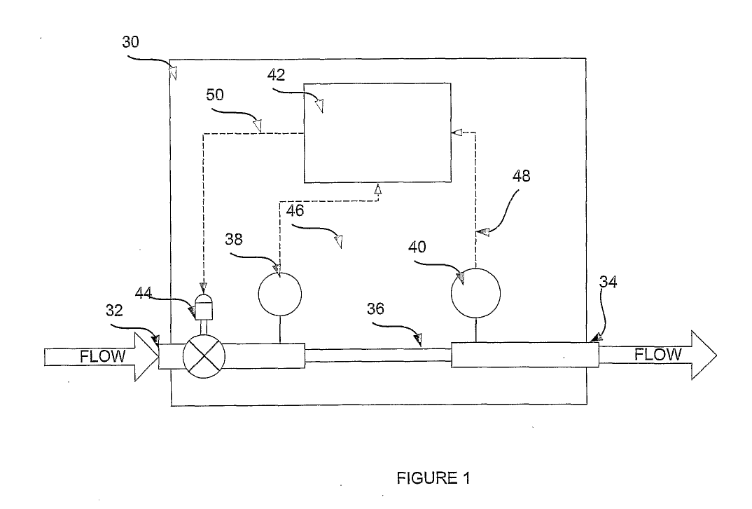

FIG. 1 is a flow control device 30, according to one embodiment of the present invention. Flow control device 30 can include an inlet 32 for receiving a flow, an outlet 34 for directing a flow to other components of a flow system, a constricted area 36 (e.g., an orifice plate, small diameter tube or other constriction known in the art), a pressure sensor 38 upstream of constricted area 36 (referred to as the “upstream pressure sensor”) configured to measure an upstream pressure, a pressure sensor 40 downstream of constricted area 36 (referred to as the “downstream pressure sensor”) configured to measure a downstream pressure, a controller 42, which can include processors, memories and software instructions for determining a fluid flow rate and/or for generating a valve control signal, and a valve 44 (e.g., a throttling gate valve, a poppet valve, a butterfly valve, a pneumatically driven valve or other valve known in the art) responsive to the valve control signal to regulate fluid flow.

Upstream pressure sensor 38 and downstream pressure sensor 40 can be capacitance type, piezoresistive type, transducer type or other type of pressure sensor known in the art. The portions of upstream pressure sensor 38 and downstream pressure sensor 40 exposed to the fluid flowing through flow control device 30 can be chemically inert with respect to the fluid. Controller 42 can be coupled to upstream pressure sensor 38, downstream pressure sensor 40 and valve 44 via, for example, electrical connections. Valve 40 can further include components, such as microcontrollers, to process the valve control signal and open or close valve 44 in response to the valve control signal.

A fluid (gas or liquid) can enter flow control device 30 at inlet 32, pass through valve 44 and constriction 36 and exit flow control device 30 at outlet 34. Upstream pressure sensor 38 and downstream pressure sensor 40 can generate upstream pressure signal 46 and downstream pressure signal 48, which can be digital or analog signals that represent the pressure measurements at upstream pressure sensor 38 and downstream pressure sensor 40, respectively.

Controller 42, using, for example, software instructions stored on a computer readable medium, can generate valve control signal 50 to open or close valve 44 to achieve a desired flow rate based on the pressures measured by upstream pressure sensor 38 and/or downstream pressure sensor 40. According to one embodiment of the present invention, controller 42 can determine a differential between the upstream pressure measurement and the downstream pressure measurement. The differential can be any representation of the difference between the pressure measurements at upstream pressure sensor 38 and downstream pressure sensor 40. For example, the differential can be represented as a pressure value (e.g., 100 Pa) or as a signal having a particular voltage value (e.g., 100 mV), or in any other format that represents the difference between the pressure measurements. Controller 42 can compare the differential to a set point to generate valve control signal 50 according to any control scheme (e.g., proportional-integral (“PI”) control scheme, proportional-integral-derivative (“PID”) control scheme, or any other control scheme known or developed in the art). According to one embodiment of the present invention, the set point can be determined from a calibration curve polynomial based on an input mass or volumetric flow rate. Based on control signal 50, valve 44 can open or close to regulate the flow rate. It should be noted that the flow controller of FIG. 1 is provided by way of example.

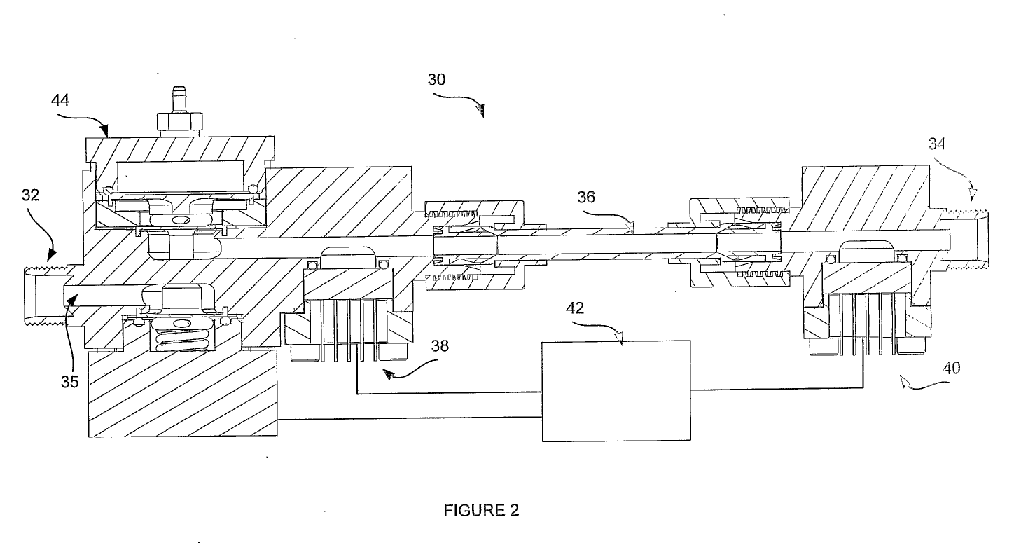

FIG. 2 is a diagrammatic representation of one embodiment of flow control device 30. Flow control device 30 can include an inlet 32 for receiving a flow, an outlet 34 for directing a flow to other components of a flow system, a flow passage 35, for directing fluid from inlet 32 to outlet 34, a constricted area 36, an upstream pressure sensor 38, a downstream pressure sensor 40, a controller 42 to generate a valve control signal, and a valve 44 to regulate fluid flow responsive to the valve control signal.

Controller 42 can receive signals from upstream pressure sensor 38 and downstream pressure sensor 40 representing the measured pressure at the respective sensor. The signal can be an analog or digital signal that can represent the measured pressure by voltage level, as bits representing the measured pressure or in any other manner known in the art. Controller 42 can determine a differential between the measured pressures, by for example, generating a difference signal and/or calculating a pressure difference. Controller 42 can generate a valve control signal based on the differential or based on the pressure signal received from the upstream and/or downstream pressure sensor. Valve 44 can open or close responsive to the received valve control signal.

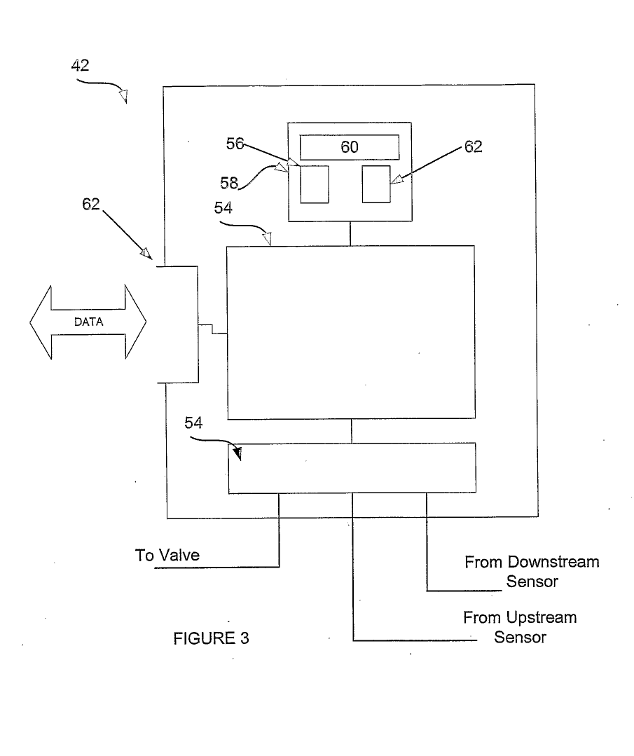

FIG. 3 is a diagrammatic representation of one embodiment of controller 42. Controller 42 can include an analog to digital (A/D) converter 52 to receive signals from the upstream pressure sensor and downstream pressure sensor and convert the received signals to a digital format. Processor 54 (e.g., CPU, such as an 8051 processor by Intel Corporation of Santa Clara, Calif., an ASIC, a RISC processor, such as a PIC 18c452 processor by Microchip Technologies of Chandler, Ariz., or other processor) can receive digital values from A/D converter 52, representing the measured pressures, and calculate a differential. Based on the differential or the measured pressure from either the upstream or downstream sensor, processor 54 can generate a digital control signal that represents how much a valve should open or close to regulate fluid flow. A/D converter 52 can convert the digital value to an analog valve control signal and send the analog control valve signal to the valve.

Processor 54 can generate the digital control signal by executing a control program that can include a control program 56 on a computer readable memory 58 (e.g., EEPROM, RAM, ROM, flash memory, magnetic storage, optical storage or other computer readable memory known in the art), accessible by processor 54. In one mode of operation, the control algorithm can calculate a differential pressure set point based on a flow rate set point input and a calibration data 60 stored on computer readable medium 58. The control program can use the specified set point and calibration data to calculate the digital control signal based on the differential between measured pressures. In another mode of operation, the control algorithm can use the measured pressure at an upstream or downstream pressure sensor to calculate the digital control signal as described in U.S. patent application Ser. No. 10/777,300.

The control algorithm can calculate the digital control signal for a particular mode of operation using any control scheme known in the art, including, but not limited to, a PID, a modified PID with offset or other control algorithm known in the art. The basic operation creates an error signal. The error signal is then corrected for the particular valve. The corrected error signal is converted from digital format to an analog signal by A/D converter 52, and the resulting analog signal is sent to a voltage-to-current converter that drives the control valve to a new position.

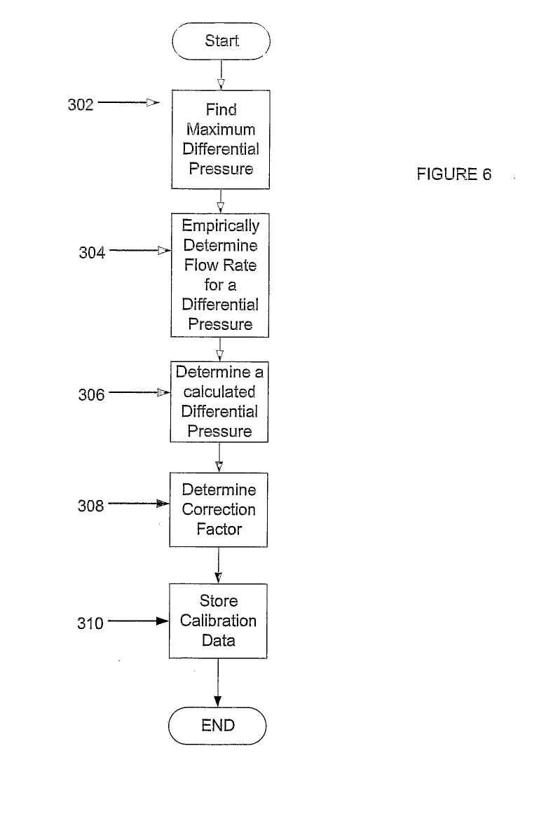

Calibration data 60 can include, for example, coefficients for one or more polynomial expressions representing a calibration curve and one or more correction factors for applying the polynomial expression to particular conditions. The polynomial expression can represent a calibration curve for differential flow control and/or a calibration curve for single pressure sensor control. According to one embodiment of the present invention, controller 42 can include a calibration program 62 to update the calibration data, as describe below in conjunction with FIG. 6.

Controller 42 can include additional input/output capabilities. For example, controller 42 can have interfaces to support administrative functions such as updating control program 56, calibration data 60 or calibration program 62. Additionally, controller 42 can include network interfaces (e.g., interface 64) to communicate with other flow control devices, administrative computers or other devices capable of communicating over a network. It should be noted that control program 56 and calibration program 60 can comprise a single set of computer instructions, be separate programs, be modules of the same program or be implemented according to any suitable programming architecture as would be understood by those of ordinary skill in the art. It should be further noted that the controller of FIG. 3 is provided by way of example and other controllers can be utilized.

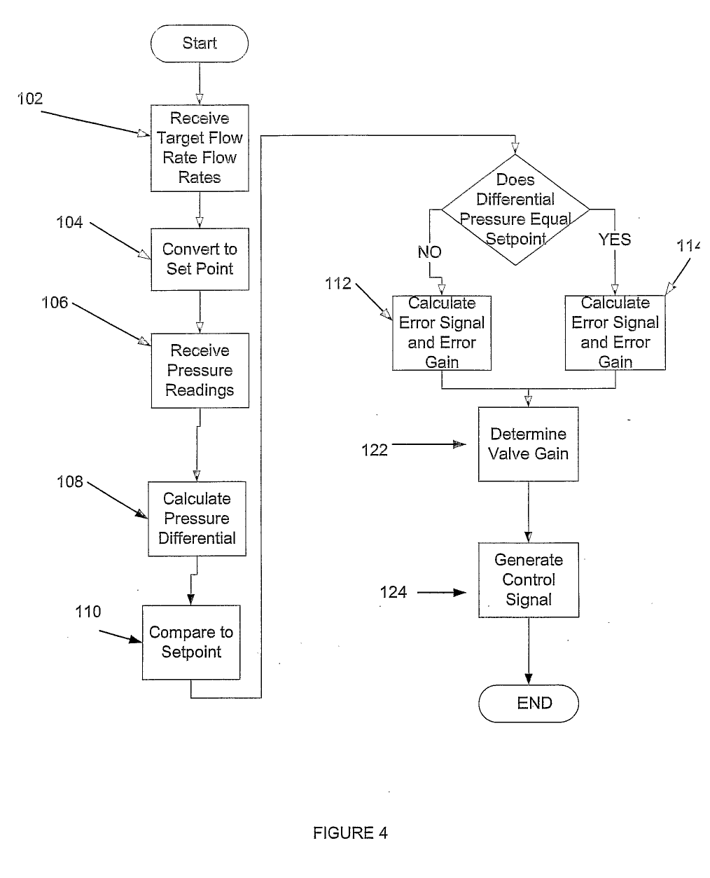

FIG. 4 illustrates one embodiment of a control routine that can be implemented as, for example, a set of computer readable instructions executable by a processor of a controller. At step 102, the controller can receive a target mass flow or volumetric flow rate to be achieved. The controller can apply calibration data to the received flow rate (step 104) to derive a set point.

According to one embodiment of the present invention, the controller can determine the set point by applying an n^{th} degree polynomial to the flow rate. Application of the n^{th} degree polynomial can include applying a polynomial expression based on a calibration curve and a correction factor to correct the expression for the conditions under which the flow control device functions. One embodiment of determining the correction factor is described in conjunction with FIG. 6.

At step 106, the controller can read upstream and downstream pressure signals from, for example, an analog to digital converter. At this point, the upstream and downstream pressure signals can be voltage samplings (i.e., digital samplings) representing the analog voltages produced by the pressure sensors. The controller can convert the received samplings into pressure values. At step 108, the controller can calculate the differential pressure from the upstream and downstream pressure readings.

At step 110 the controller can compare the differential pressure to the set point. If the differential pressure does not equal the set point, the controller, at step 112, can generate an error signal based on the difference between the differential pressure and the set point and calculate an error gain based on the pressure from a particular sensor (e.g., the measured pressure from the downstream sensor). If, conversely, the flow rate does equal the set point, the controller can calculate the error gain based on the differential between the measured pressures (step 114). The error gain can be added to the error signal to compensate for low signal values at low pressures.

At step 122, the controller can determine a valve gain. The valve gain adjusts the gain of the signal that will be applied to the valve proportionally to the current position. The gain can be determined from, for example, a gain curve stored in memory. The gain curve allows the system to correct for variations from valve to valve. In addition to correcting for variations in a particular valve, the valve gain curve can also compensate for overshoot, undershoot, and response time. According to one embodiment of the present invention, a sensitivity factor can be applied to the valve gain curve to slow or speed up the valve response.

The controller, at step 124, can output a control signal based on the error signal, valve gain and other factors as would be understood by those of skill in the art. The control signal can direct a valve to open or close to bring the differential pressure closer to the set point. It should be noted that the control algorithm of claim 4 is provided by way of example only and any control algorithm known in the art can be utilized. Moreover, flow control based on a pressure differential is also provided by way of example, and other embodiments of the present invention control flow based on the pressure at a single sensor or other according to other schemes. PCT application PCT/US03/22579, U.S. patent application Ser. No. 10/777,300, and U.S. patent application Ser. No. 10/779,009 describe other control algorithms that can be employed by embodiments of the present invention.

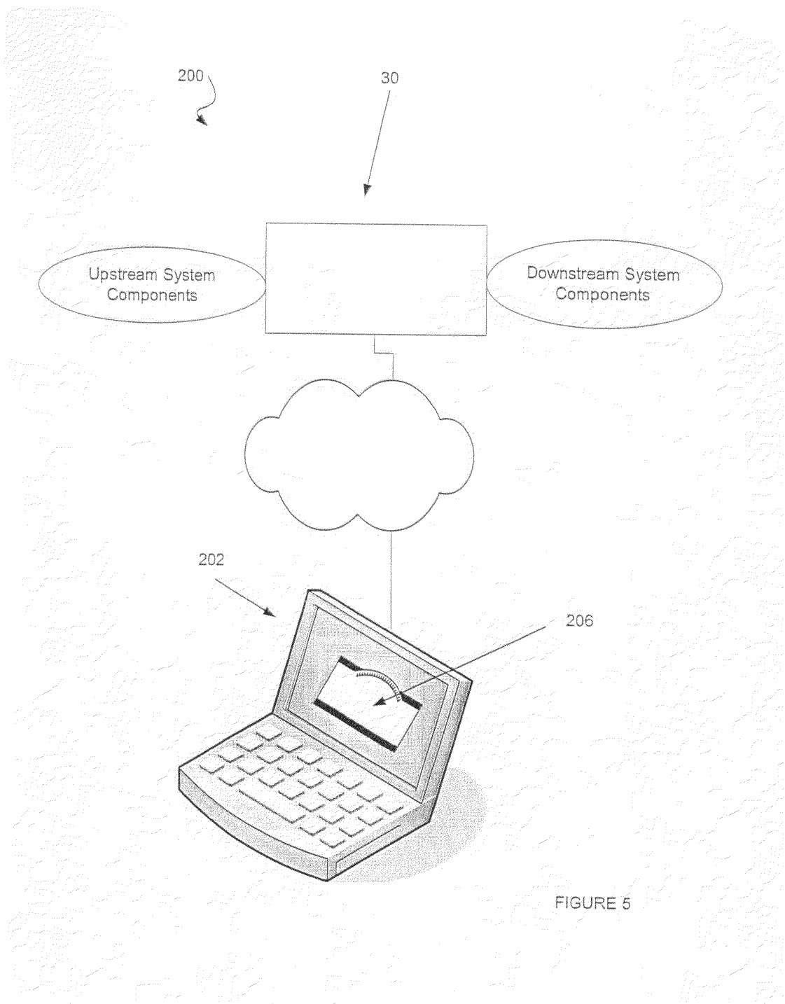

FIG. 5 is a diagrammatic representation of one embodiment of a system 200 for calibrating flow device 30. In system 200, flow device 30 can be installed in the system in which it will operate or a test system simulating the system under which it will operate. Flow device 30 can be connected to an upstream fluid flow path that includes, for example, pumps, filters or other flow components and a downstream flow path that can also include flow components. System 200 can further include a calibration computer 202 (e.g., laptop, desktop, PDA or other computing device known in the art) connected to flow controller 30 via a data transport medium (e.g., a bus, a connector, a network or other data transport medium known in the art). The controller (e.g., controller 42) of flow control device 30 can communicate data to and receive data from calibration computer 202 via the data transport medium.

Flow device 30 can include a calibration program (e.g., calibration program 62 of FIG. 3) to calculate a correction factor that can be stored, for example, as part of calibration data 60. Calibration computer 202 can include an interface program to display a graphical user interface (“GUI”) 206 or other interface for the calibration program. Calibration computer 202 can communicate inputs received from a user to the calibration program and display outputs to the user. In this embodiment of the present invention, calibration computer 202 simply provides an interface for the calibration program stored on flow device 30. According to other embodiments of the present invention, calibration computer 202 can include the calibration program and simply upload calibration data to flow controller 30. Where the correction factor, sensitivity factor or other calibration data is calculated can change as needed or desired for a particular implementation.

According to one embodiment of the present invention a calibration curve can be established for flow controller 30 before flow controller 30 is installed in system 200. This can be done, for example, using a test fluid, such as isopropyl alcohol (“IPA”) or other test fluid, and a test system. The calibration curve can be established according to any method known in the art. According to one embodiment, the flow rates for various differential pressures can be determined. Assume for example, for flow controller 30, fifteen samples are taken at various differential pressures to produce the data in Table 1:

TABLE 1

| Run Time | | | |
|---|---|---|---|
| (sec) | ΔP | Mass Dispensed | Flow Rate |
| 10 | 0.25 | 0.295 | 0.03 |
| 10 | 0.5 | 0.610 | 0.06 |
| 10 | 0.75 | 0.911 | 0.09 |
| 10 | 1 | 1.213 | 0.12 |
| 10 | 2 | 2.415 | 0.24 |
| 10 | 4 | 4.685 | 0.47 |
| 10 | 6 | 6.730 | 0.67 |
| 10 | 8 | 8.605 | 0.86 |
| 10 | 10 | 10.356 | 1.04 |
| 10 | 13 | 12.865 | 1.29 |
| 10 | 16 | 15.220 | 1.52 |
| 10 | 19 | 17.544 | 1.75 |
| 10 | 22 | 19.655 | 1.97 |
| 10 | 25 | 21.717 | 2.17 |
| 10 | 27 | 23.031 | 2.30 |

In the example of Table 1, the calibration curve can be represented by an n^{th} degree polynomial. For a 2^{nd} degree polynomial curve fit, the calibration curve of table 1 can be represented generally as follows:

ΔP=ax²+bx+c [EQN. 1]

and more specifically as:

ΔP=1.64237660x²+7.950469544x−0.011737883 [EQN. 2]

The coefficients of the polynomial expression (i.e., a, b and c) can be stored in flow control device 30 by the manufacturer, a third party or be provided in another manner. It should be noted that the calibration curves can be derived in any manner, including any curve fitting scheme, known in the art and can be represented by other n^{th} degree polynomials. Additionally, the polynomial can be forced to a zero y intercept. In this case, the c term (e.g., −0.00111737883) can be dropped and the a and b terms adjusted for the curve fit. Forcing the polynomial to a zero y intercept helps minimize skewing of the curve for higher viscosity process fluids or greater pressure drop devices.

In practice, the process fluid and system in which flow control device 30 is installed will differ from the test fluid and test system. To compensate for this, the calibration program can determine a correction factor for the flow control device. FIG. 6 is a flow chart illustrating one embodiment of a method of updating the calibration data to account for various process parameters and the process fluid. It is assumed, for purposes of FIG. 6, that the flow controller is installed in the system in which it will operate or a substantially similar system (e.g., a test rig that simulates the system in which it will operate). The process of FIG. 6 can be implemented by a calibration program residing on a flow controller or a computer (e.g., calibration computer 202) that can communicate with the flow controller.

At step 302, a maximum differential pressure test can be performed to determine the maximum differential pressure under which the flow controller is expected to operate. For step 302, the calibration program opens the valve of the flow controller to its maximum open position for a first period of time (t₁) (e.g., ten seconds or other arbitrarily selected time) sufficient to allow the differential pressure of the fluid flow to stabilize and minimize startup and end-of-dispense effects that can affect the total mass or volume reading relative to the dispense time. The differential between the pressure at the upstream pressure sensor and downstream pressure when the valve is fully open is the maximum differential pressure (ΔPₘₐₓ). ΔPₘₐₓ represents the maximum differential pressure that the flow controller is expected to experience during operation.

If the pressure sensors of the flow controller have a maximum pressure for which they are designed (a “maximum operating pressure”), the configuration program can account for this in the maximum differential pressure test by setting the maximum differential pressure to a level that will prevent the maximum operating pressure of a sensor from being exceeded. As an example, if an upstream pressure sensor has a maximum operating pressure of 30 psi, but opening the flow controller valve completely will cause the pressure at the upstream pressure sensor to exceed 30 psi, the configuration program can select a valve setting that causes the pressure at the upstream pressure sensor to be below 30 psi, say 28 psi. In this case, the configuration program will monitor the upstream pressure and open the valve until the upstream pressure is 28 psi or other predetermined pressure limit. The pressure differential when the upstream pressure is 28 psi or other pressure limit can be selected as the maximum pressure differential ΔPₘₐₓ. The flow device can further set a maximum flow rate for the flow device at a flow rate that is some percentage of ΔPₘₐₓ. For example, the configuration program can set the maximum flow rate to be the flow rate that occurs at 0.95 ΔPₘₐₓ.

Thus, the configuration program can select the maximum differential pressure as the differential pressure experienced when the valve is in the fully open position or a differential pressure that maintains the pressure at the upstream or downstream sensor beneath a predetermined pressure limit. If a flow rate is later selected that would cause the set point to exceed the maximum pressure differential, the flow controller can return an error or simply use the maximum differential flow rate as the set point.

At step 304, an empirical flow rate can be determined for the flow controller. The calibration program, according to one embodiment of the present invention, can direct the valve to open for a second period of time (t₂) to produce a flow having a non-maximum differential pressure (ΔPₜₑₛₜ) that is less than the maximum differential pressure. According to one embodiment of the present invention ΔPₜₑₛₜ can be approximately half of ΔPₘₐₓ. The valve, in this example, can be opened such that ΔPₜₑₛₜ is half of ΔPₘₐₓ for ten seconds or other period of time sufficient to allow the flow to equilibrate. At the end of t₂, the amount of fluid (z) dispensed by the flow controller can be determined. The empirical flow rate (xₑₘₚ) can be determined according to:

$${x}_{emp} = \frac{z}{{t}_{2}} \qquad [ EQN . 3 ]$$

The calibration program, at step 306, can determine a calculated differential pressure (ΔP_{calc}) using xₑₘₚ as the flow rate for the n^{th} degree polynomial.

ΔP_{calc}=axₑₘₚ²+bxₑₘₚ+c [EQN. 4]

Using the example coefficients from EQN. 2, the expression becomes:

ΔP_{calc}=1.64237660xₑₘₚ²+7.950469544xₑₘₚ−0.011737883 [EQN. 5]

If for example, step 304 results in xₑₘₚ=2.72 g/sec for a ΔPₜₑₛₜ=13, ΔP_{calc} will equal 33.81.

The correction factor for the calibration curve can be determined, at step 308, according to:

F=ΔPₜₑₛₜ/ΔP_{calc} [EQN. 6]

Continuing with the previous example, the correction factor can be approximately 0.38. The correction factor can be used to adjust the n^{th} degree polynomial curve generated using the test fluid. The correction factor can compensate for differences between the test fluid and process fluid and differences in the system in which the flow controller is installed from the system in which the controller was calibrated. The correction factor can be applied, for example, when determining a pressure differential, such as a set point, for a given flow rate. The flow controller can determine a corrected pressure differential (ΔP_{corr}) according to:

ΔP_{corr}=F(ax²+bx+c) [EQN. 7]

At step 310, the calibration program can store the calibration data. According to one embodiment of the present invention, as the coefficients of the n^{th} degree polynomial will already be saved, this can be done by simply saving the correction factor. According to another embodiment of the present invention, new coefficients for the calibration curve can be stored (e.g., Fa, Fb and Fc). The corrected calibration curve can also be stored in any other manner as would be understood by those in the art. It should also be noted that multiple correction factors and/or polynomials can be stored in a single flow controller, allowing the flow controller to be used in a variety of conditions. Additionally, the calibration program can save the maximum flow rate (e.g., the flow rate that occurs at 0.95 ΔPₘₐₓ or other maximum flow rate) for the device. While, in the example discussed above, only one empirical test is discussed to calculate F, multiple tests can be used. For example, the flow device can be configured to cause flows at ΔPₜₑₛₜ₁, ΔPₜₑₛₜ₂, ΔPₜₑₛₜ₃, to calculate F₁, F₂ and F₃ respectively. F₁, F₂ and F₃ can then be averaged (or otherwise used) to produce F. According to another embodiment F₁, F₂ and F₃ can be applied at different ranges of ΔP when the flow device is controlling or monitoring flow. Thus, multiple tests can be done to calculate the correction factor or multiple correction factors. Additionally, multiple empirical tests can be performed such that a correction factor for each coefficient can be found.

ΔP_{corr}=F₁ax²+F₂bx+F₃c [EQN. 8]

Moreover, as will be discussed in conjunction with FIG. 14, multiple tests can be performed to produce a curve without a correction factor.

In some cases, use of EQN 7 to convert an input flow rate to a set point may result in a slight offset between a flow rate entered and the actual flow rate achieved. For example, assume the target flow rate is 100 mL/sec, but the flow controller, even after applying the correction factor, dispenses 103 mL/sec. In this case a rate correction can be determined to account for this offset.

According to one embodiment of the present invention, the rate correction can be determined by providing a target flow rate to the flow controller. The flow controller, based on EQN 7, can determine the set point pressure differential and apply the control algorithm to the set point pressure differential to open the valve to achieve the set point pressure differential. The valve can be opened for a third period of time (t₃), say 10 seconds, and the amount of fluid dispensed by the flow controller can be measured. From this, the actual flow rate can be determined. The calibration program can compare this flow rate to the target flow rate to determine the flow correction. In the example above, the flow correction will be −3 mL/sec. The flow correction can then be applied to each target flow rate provided to the flow controller.

One embodiment of the calibration program can also suggest a sensitivity factor. The sensitivity factor can be applied to the valve gain curves used by the control loop to cause the response time of the flow controller to increase or decrease. The response time is the time from when a signal is sent to the flow device to when the flow controller reaches set point. The sensitivity factor is a gain value for the valve to which the response time is dependent. The higher the sensitivity factor, the faster the response time. The controller can be configured to have a baseline sensitivity factor (SC_{base}). If the response time (tᵣₑₛₚ) of the flow controller is shorter than a first response time (e.g., 0.4 seconds or other arbitrarily defined response time) or longer than a second response time (e.g., 0.8 seconds or other arbitrarily defined response time), the calibration program can suggest a new sensitivity factor (SC_{sug}) that brings the response time of the flow controller to within the first and second response times. It should be noted that a sensitivity factor can be used to adjust a single parameter or various parameters of the control algorithm to increase or decrease sensitivity.

The first and second response times can be determined by, for example, the flow controller manufacturer based on the characteristics of the flow controller. The first response time can be sufficiently long that, if tᵣₑₛₚ is greater than or equal to it, the flow controller will not experience significant oscillations in the flow. The second response time can be sufficiently short that, if tᵣₑₛₚ is less than or equal to it, the flow will reach the set point pressure differential quickly enough that the response time does not significantly affect the volume of liquid output by the flow controller.

The algorithm used for determining SC_{sug} can be established based on empirically determined data by, for example, the flow controller manufacturer. Example equations for determining SC_{sug} can include for example:

SC_{sug}=SC_{base}−(SC_{base}*3*(0.5−tᵣₑₛₚ)) [EQN. 9]

if tᵣₑₛₚ is less than 0.4 seconds and

SC_{sug}=SC_{base}*(1+tᵣₑₛₚ−0.6) [EQN. 10]

if tᵣₑₛₚ is greater than 0.8 seconds.

The calibration program of the present invention can thus quickly and easily calibrate a flow controller for a particular process system. Embodiments of the present invention can include determining a correction factor based on i) a differential pressure calculated using a measured flow rate xₑₘₚ and a calibration curve polynomial (e.g., ΔP_{calc}) and ii) the differential pressure (ΔPₜₑₛₜ) that resulted in xₑₘₚ. Additionally, the calibration program can determine a flow correction and suggest a sensitivity factor.

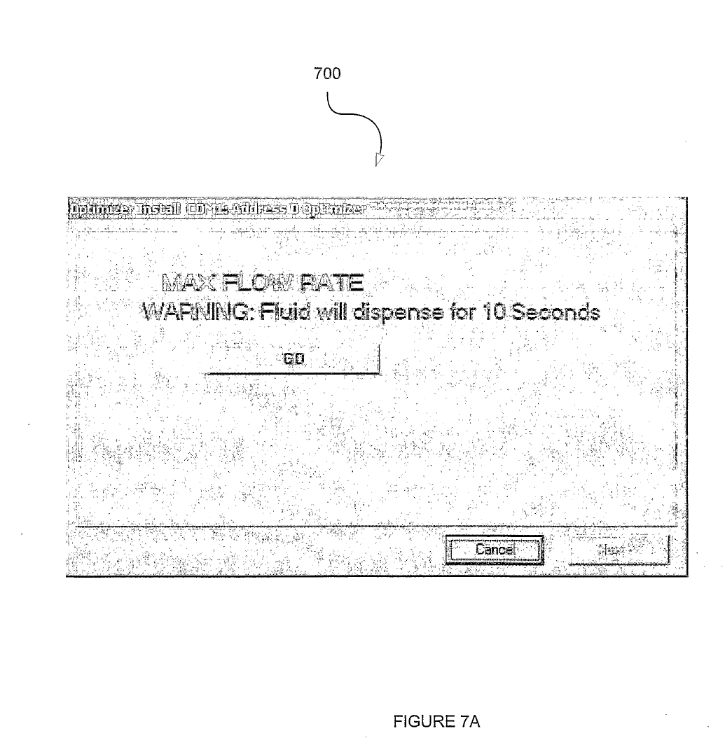

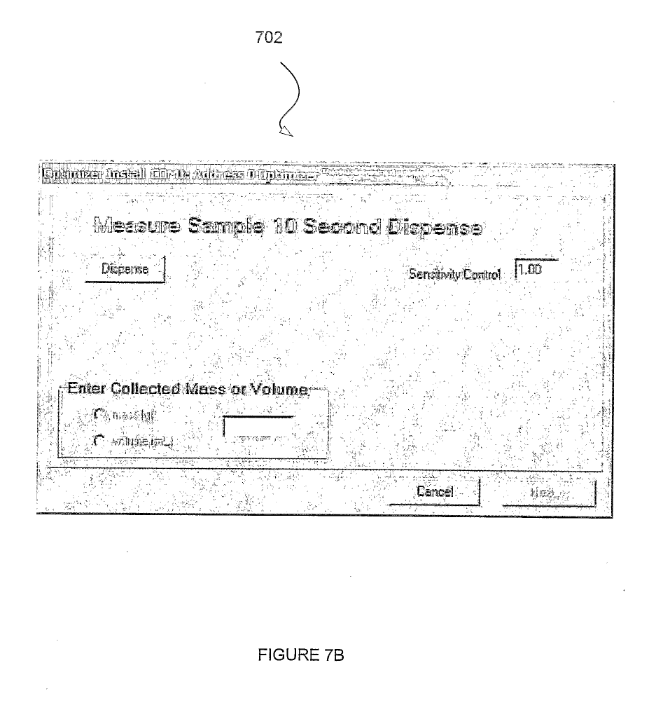

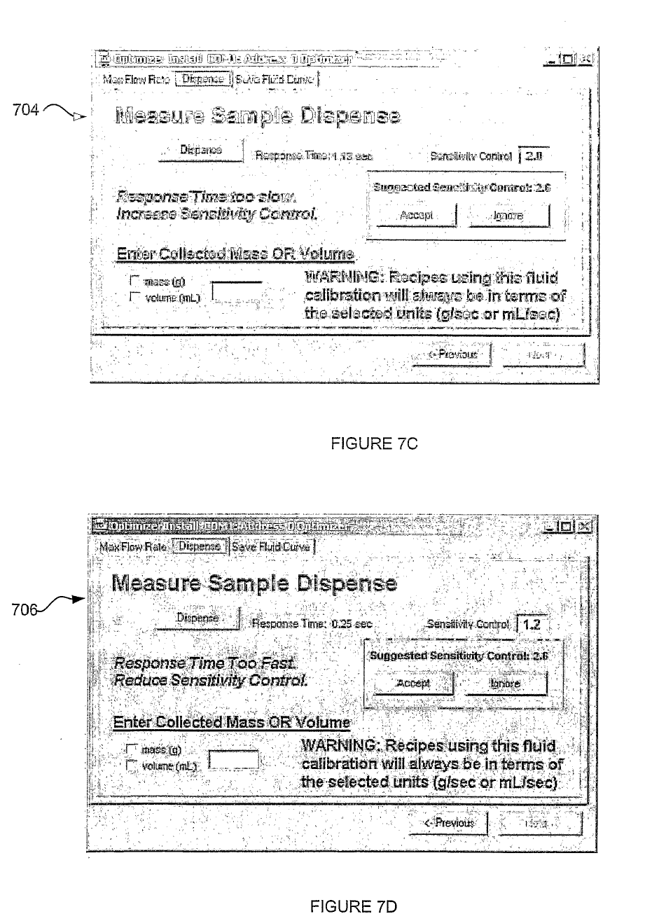

A user can interact with the calibration program using a GUI or man machine interface (“MMI”). According to one embodiment of the present invention, while the calibration program runs in the controller of the flow control device, the GUI can be presented at another computer, such as a laptop or desktop coupled to the flow control device, as described in conjunction with FIG. 5. FIG. 7A provides an example embodiment of a screen 700 for initiating a calibration process. Screen 700 indicates to the user that the flow control device will dispense fluid for ten seconds (e.g., t₁) and allows the user to proceed by “clicking” the “GO” button. FIG. 7B provides an example embodiment of a screen 702 for performing a dispense for period t₂ and entering the amount of liquid dispensed (z) after the period t₂. From z, the calibration device can determine xₑₘₚ, calculate ΔP_{calc} and determine F. Additionally, screen 702 allows the user to adjust the sensitivity factor.

FIGS. 7C and 7D illustrate screens 704 and 706 respectively. Screens 704 and 706 represent other embodiments of screen 702 that allow a user to initiate a dispense process and input z. Screens 704 and 706 also display a suggested sensitivity factor (SC_{sugg}) and allow the user to accept or reject the suggested sensitivity factor. Screen 704 illustrates a suggested sensitivity factor when the response time is too long and Screen 706 illustrates a suggested sensitivity factor when the response time is too short. It should be noted that the screens of FIGS. 7A-7D are provided by way of example only and any suitable interface can be provided. It should be noted that the MMI can also report other information to a user including the maximum flow rate determined by the calibration program and other calibration information.

Embodiments of the present invention have been discussed primarily in terms of differential pressure control. However, it should be noted that embodiments of the present invention can also be utilized for single pressure sensor control. This can be done by substituting pressures at a particular sensor for the differential pressures in the process of FIG. 6. In this case a calibration curve is established based on the pressure (P) read by a particular pressure sensor (e.g., the upstream or downstream pressure sensor) for a test fluid under test conditions. As with a differential pressure calibration curve, a single pressure calibration curve can be represented by an n^{th} degree polynomial. In situ, the calibration program can determine a Pₘₐₓ. The calibration program can also perform a dispense process for t₂ at a Pₜₑₛₜ that is less than Pₘₐₓ and determine the amount of volume dispensed (z). z and t₂ can be used to determine xₑₘₚ. The n^{th} degree polynomial can be applied to xₑₘₚ to determine a P_{calc}. The correction factor F can be determined based on the ratio of Pₜₑₛₜ to P_{calc.}

Additionally, it should be noted that embodiments of the present invention can be applied to ultrasonic flow controllers in which the control method is based on the difference of transmit times between an upstream and downstream transmitter. The calibration program can open the flow control valve to a maximum setting for a period of time (t₁) to determine a maximum difference in transmit times (Δtₘₐₓ) for the flow controller. The calibration program can also run a dispense for a set time (t₂) at a set transmit time difference (Δtₜₑₛₜ) and determine an amount of liquid dispensed (z). From z and t₂, Xₑₘₚ can be determined. An n^{th} degree polynomial representing the calibration curve for the flow controller can be applied to xₑₘₚ to determine a calculated time differential (Δt_{calc}) for that flow rate. The correction factor can be based on the ratio of Δtₜₑₛₜ and Δt_{calc}.

Thus, according to one embodiment a flow device can be directed to open a valve to produce a flow rate such that a variable indicative of the flow rate, such as ΔP, P, Δt or other variable indicative of flow rate has a test value (e.g., ΔPₜₑₛₜ, Pₜₑₛₜ, Δtₜₑₛₜ). The empirical flow rate can be determined for the flow for a time period. A calibration curve is applied to the empirical flow to determine a calculated value for the variable (e.g., ΔP_{calc}, P_{calc}, Δt_{calc}). A correction factor for the calibration curve can then be determined based on the test value and the calculated value of the variable.

In the examples above, the correction factor remains constant. According to other embodiments of the present invention, the correction factor can vary with flow rate. In this case, the calibration program can determine the differential pressure (ΔPₜₑₛₜ) at multiple empirical flow rates. For example, the ΔPₜₑₛₜ can be determined for a flow rate near the high end and low end of the flow rate range for the controller to give ΔPₜₑₛₜ₁ and ΔPₜₑₛₜ₂. F₁ and F₂ can be determined from EQN 7 using a ΔP_{calc1} and ΔP_{calc2} for corresponding empirical flow rates. A linear fit or curve fit can be performed to develop an equation for change in F over the flow rates. This equation, or the coefficients for the equation, can be stored at the flow controller so that the correction factor can be determined for a given flow rate.

According to another embodiment of the present invention, a flow control device can be quickly calibrated based on the dynamic viscosity (μ) and density (ρ) of a fluid or kinematic viscosity (ν=μ/ρ) of the fluid. The flow control device can also be calibrated based on just the dynamic viscosity of the process fluid. Given a calibration flow curve expressed as the n^{th} degree polynomial:

ΔP=ax²+bx [EQN. 11]

The coefficients of the calibration flow curve can be adjusted according to the dynamic viscosity, the dynamic viscosity and density or kinematic viscosity to yield the corrected flow curve:

ΔP=a_{cor}x²+b_{cor}x [EQN. 12]

The coefficients of equation 11 are corrected using viscosity based correction factors. Turning first to calibration using kinematic viscosity or dynamic viscosity and density, the coefficients of the calibration flow curve are adjusted as follows:

a_{cor}=a*((ν*D₁)+D₀) [EQN. 13]

b_{cor}=b*(b*(ν^{0.5}*E₁)+E₀) [EQN. 14]

or

a_{cor}=a*(((μ/ρ)*D₁)+D₀) [EQN. 15]

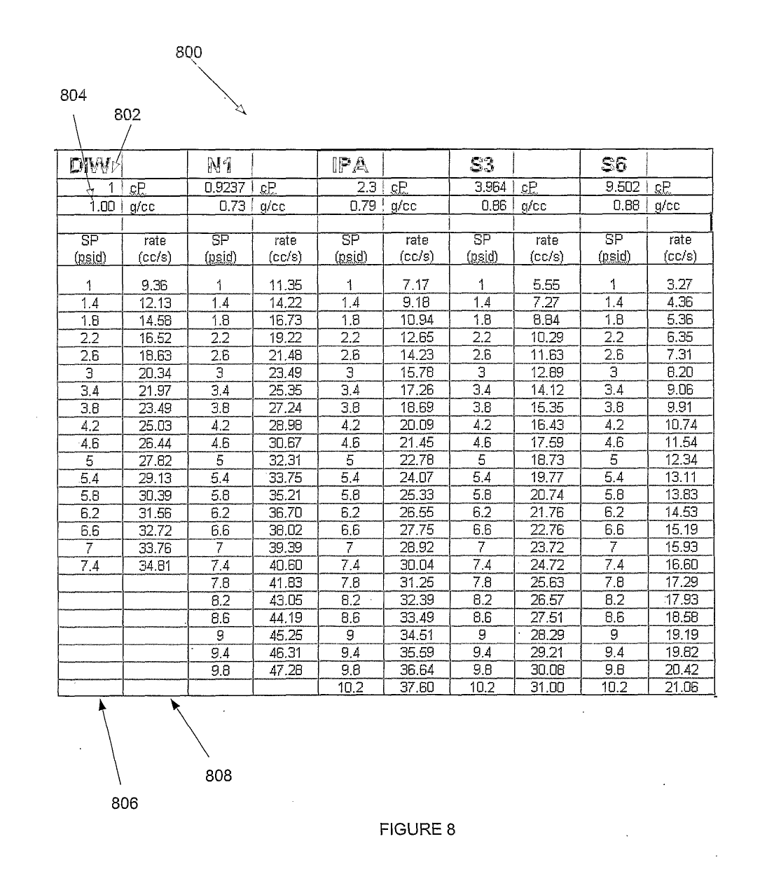

b_{cor}=b*(b*((μ/ρ)^{0.5}*E₁)+E₀) [EQN. 16]

where D₀, D₁, E₀, and E₁ are viscosity correlation variables. The viscosity correlation factors are essentially a set of correction factors that apply to the coefficients of the calibration flow curve to adjust the calibration flow curve for a particular process fluid. One embodiment of developing the viscosity correlation variables is discussed below in conjunction with FIGS. 8-10.

FIG. 8 is a table 800 of example data for deionized water (“DIW”), N1 (calibration oil), IPA (isopropyl alcohol), S3 (calibration oil) and S6 (calibration oil) of pressure differential versus flow rate. For each fluid, table 800 provides dynamic viscosity μ (see 802 for DIW), density ρ (see 804 for DIW) a column of example pressure differential values (column 806) and a column of corresponding example flow rates (column 808). Table 2 shows the coefficients (a and b) for an n^{th} degree polynomial, forced to zero, for each fluid based on a curve fit.

TABLE 2

| | DIW | N1 | IPA | S3 | S6 |
|---|---|---|---|---|---|
| a | .00434424 | .00328734 | .00373642 | .00539565 | .00930764 |
| b | .05974385 | .04960288 | .013227327 | .16791807 | .29016565 |

Using the example coefficients in Table 3, the flow curve for DIW can thus be expressed as:

ΔP=0.00434424x²+0.05984385x [EQN. 17]

It should be noted that the above coefficients were derived using the Microsoft Excel “LINEST” function for a 2^{nd} degree polynomial based on the data in FIG. 8. However, any curve fitting scheme known in the art can be used.

For the sake of example, it is now assumed that the flow curve for DIW is the calibration flow curve. Each of the first order and second order coefficients of each other chemical's flow curve can be divided by the respective first order or second order coefficient of the calibration flow curve. Put another way aₒₜₕₑᵣ can be divided by a_{DIW} and bₒₜₕₑᵣ can be divided by b_{DIW}, yielding the following example results:

a_{N1}/a_{DIW}=0.75767

b_{N1}/b_{DIW}=0.8303

a_{IPA}/a_{DIW}=0.8601

b_{N1}/b_{DIW}=2.2140

aₛ₃/a_{DIW}=1.240

bₛ₃/b_{DIW}=2.7604

a_{S6}/a_{DIW}=2.1425

bₛ₆/b_{DIW}=4.8568

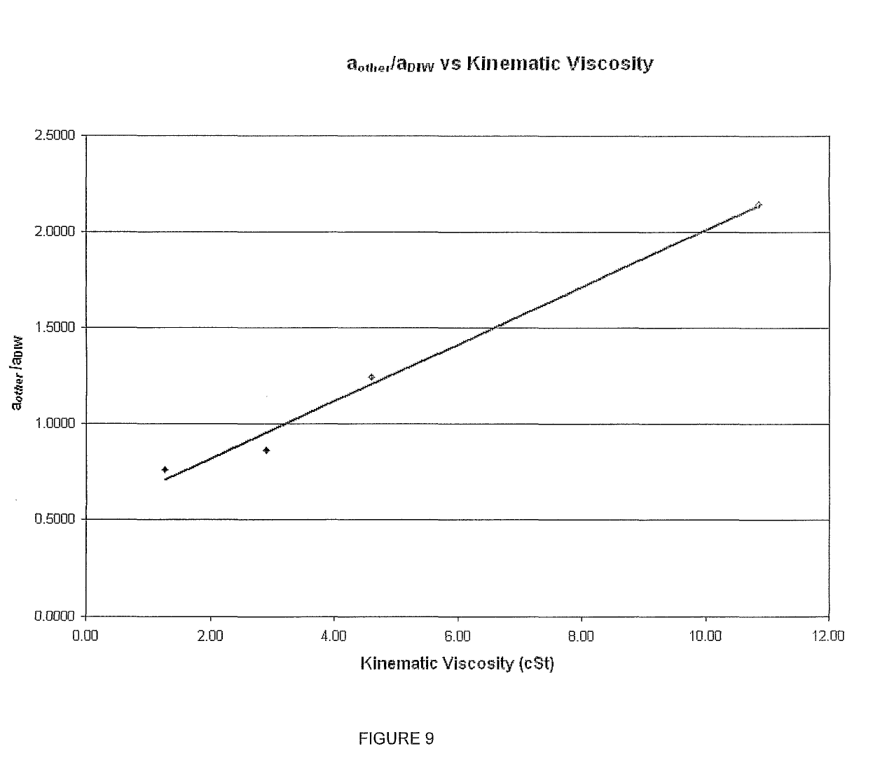

FIG. 9 illustrates a plot and line fit of aₒₜₕₑᵣ/a_{DIW} versus kinematic viscosity (ν or μ/ρ). As illustrated in FIG. 9, for the example data discussed above:

aₒₜₕₑᵣ/a_{DIW}=0.1497ν+0.5159 [EQN. 18]

Returning to equations 13 and 15 above, the viscosity correlation variables D₀ and D₁, are, for this example, respectively equal to 0.5159 and 0.1497.

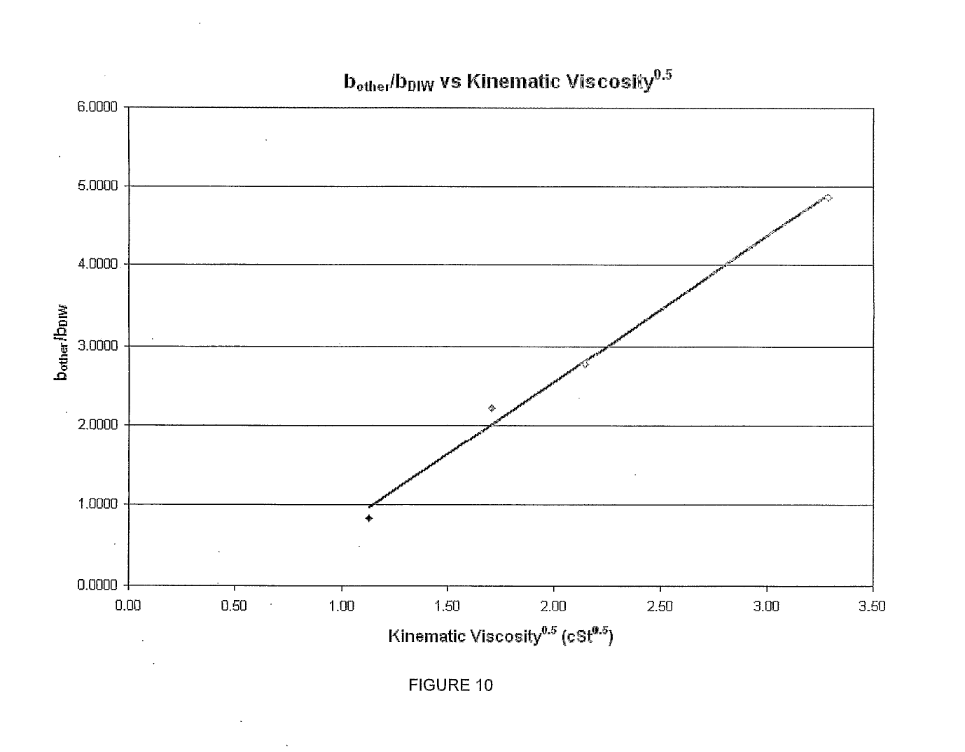

FIG. 10 illustrates a plot of bₒₜₕₑᵣ/b_{DIW} versus the square root of kinematic viscosity (ν^{0.5} or (μ/ρ)^{0.5}) As illustrated in FIG. 6, for the example data provided:

bₒₜₕₑᵣ/b_{DIW}=1.8138ν^{0.5}−1.0848 [EQN. 19]

Thus in equations 14 and 16 above, the viscosity correlation variables E₀ and E₁ are, for this example, respectively equal to −1.0848 and 1.8138.

It should be noted that equations 18 and 19 above can be derived using any suitable line fitting method (e.g., least squares or other line fitting scheme).

The coefficients of the calibration flow curve and viscosity correlation variables can be stored in a flow control device (e.g., flow control device 30) by the manufacturer, a third party or be otherwise provided. As in the example of FIG. 5 above, a calibration computer 200 can be connected to flow control device 30 to allow a user to configure the flow control device 30 using a GUI. According to one embodiment of the present invention, the user can input a kinematic viscosity or dynamic viscosity and density. Calibration computer 200 or flow control device 30 apply the viscosity correlation variables to determine corrected coefficients for flow curve. The new flow curve, adjusted based on the kinematic viscosity of the process fluid, can be stored at flow control device 30 (e.g., by storing the corrected coefficients of the n^{th} degree polynomial). Flow control device 30 can then determine the flow rate of a process fluid using the corrected flow curve.

Similarly, the manufacturing flow curve can be corrected based on dynamic viscosity. In this case the viscosity correlation variables are developed based on a curve fit of dynamic viscosity rather than kinematic viscosity. Thus, the corrected coefficients can be expressed as:

a_{cor}=a*((μ*D₁)+D₀) [EQN. 20]

b_{cor}=b*(b*(μ^{0.5}*E₁)+E₀) [EQN. 21]

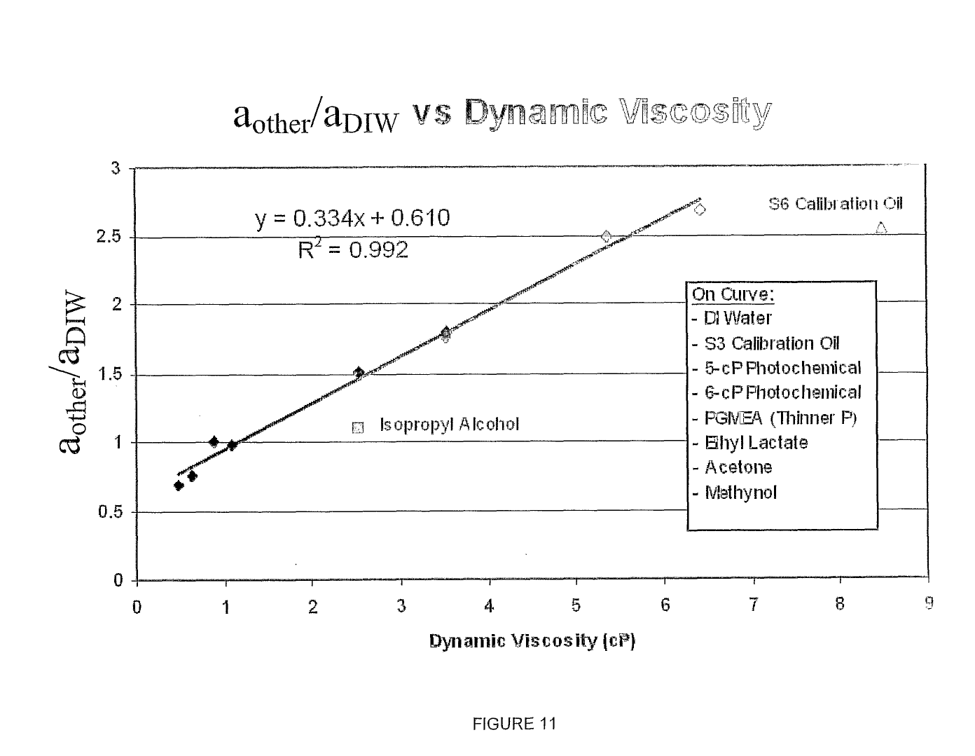

FIG. 11 illustrates a plot and line fit for a_{cor}/a_{DIW} versus dynamic viscosity. As illustrated in FIG. 11, for the example plot:

aₒₜₕₑᵣ/a_{DIW}=0.3152μ+0.6855 [EQN. 22]

Returning to equation 20 above, the viscosity correlation variables D₀ and D₁ are, for this example, respectively equal to 0.6855 and 0.3152. It can be noted that in FIG. 11, certain fluids (e.g., S6) may lie off of the curve. These test points may either be factored into the curve fit or be rejected.

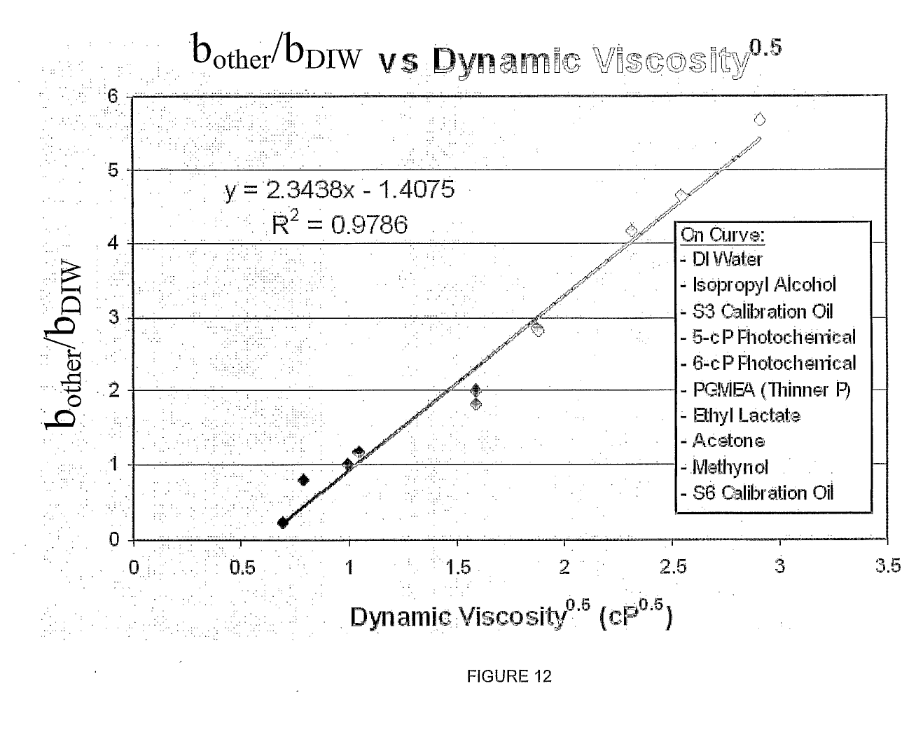

FIG. 12 illustrates a plot and line fit for b_{cor}/b_{DIW} versus the square root of dynamic viscosity. As illustrated in FIG. 12, for the example plot:

bₒₜₕₑᵣ/b_{DIW}=2.3438μ^{0.5}+1.4075 [EQN. 23]

Returning to equation 21 above, the viscosity correlation variables E₀ and E₁ are, for this example, respectively equal to 1.4075 and 2.3438. Again, test points that lie off of the curve may either be factored into the curve fit or be rejected, depending on implementation. It should be noted data for FIGS. 11 and 12 was generated using a flow controller having a 20 inch by 0.063 inch inner diameter (0.508 meter by 0.00160 meter) pressure drop coil.

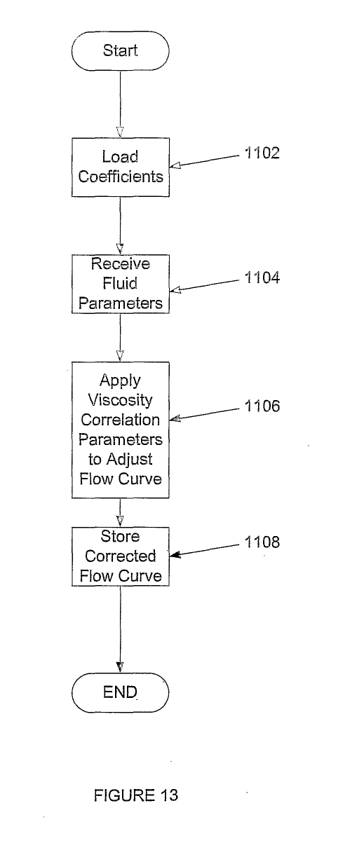

FIG. 13 is flow chart illustrating one embodiment of a method for calibrating a flow device for a particular process fluid. Embodiments of the present invention can be implemented as software programming stored on a computer readable medium (e.g., magnetic disk, optical disk, Flash memory, RAM, ROM or other computer readable medium) that can be executed by one or more processors running at the flow control device and/or a calibration computer.

A calibration flow curve is loaded by, for example loading coefficients of an n^{th} degree polynomial corresponding (step 1102) and viscosity correlation variables. A user inputs fluid parameters including, for example, kinematic viscosity, dynamic viscosity, dynamic viscosity and density (step 1104). The calibration flow curve is then adjusted based on the viscosity of the process fluid (step 1106). This can be done, for example, by applying the viscosity correlation variables to the coefficients of the calibration flow curve to yield a corrected flow curve. The corrected flow curve is stored at the flow control device (step 1108) so that the flow control device can use the corrected flow curve to determine fluid flow rates. Additionally, the corrected flow curve can be stored at the calibration computer so that the corrected flow curve can be uploaded to a new flow controller should the already calibrated flow controller be replaced. The steps of FIG. 13 can be repeated as needed or desired.

Embodiments of the present invention provide a system and method for quickly calibrating flow devices such as flow meters and mass flow controllers. Embodiments of the present invention allow a flow controller to be quickly calibrated for a particular process fluid and system. While discussed primarily in terms of a flow controller controlling a dispense process, embodiments of the present invention can be applied to any flow controller. The ability to quickly calibrate a flow controller allows for flow controllers to be swapped out in a particular system with minimum delay.

Additionally, once a correction factor, flow correction and/or sensitivity factor is determined for a flow controller in a system, it can be stored at, for example, a calibration computer. If the flow controller is replaced with a new flow controller of similar configuration in the process system, the correction factor, flow correction and/or sensitivity factor can be uploaded to the new flow controller without having to perform the calibration process. This can allow for quick replacement of a flow controller.

In the previously described embodiments, a manufacturing flow curve is adjusted based on empirical tests or viscosity correlation variables for a process fluid. According to other embodiments of the present invention, empirical tests can be performed to generate a second degree polynomial (or other n^{th} degree polynomial) for a flow curve independent of the manufacturing flow curve.

FIG. 14 is a flow chart illustrating one embodiment of a method of determining a flow curve for a flow device. It is assumed, for purposes of FIG. 14, that the flow controller is installed in the system in which it will operate or a substantially similar system (e.g., a test rig that simulates the system in which it will operate). The process of FIG. 14 can be implemented by a calibration program (e.g., calibration program 62) residing on a flow controller or a computer (e.g., calibration computer 202) that can communicate with the flow controller.

At step 1402, a maximum differential pressure test can be performed to determine the maximum differential pressure under which the flow controller is expected to operate. For step 1402, the calibration program opens the valve of the flow controller to its maximum open position for a first period of time (t₁) (e.g., ten seconds or other arbitrarily selected time) sufficient to allow the differential pressure of the fluid flow to stabilize and minimize startup and end-of-dispense effects that can affect the total mass or volume reading relative to the dispense time. The differential between the pressure at the upstream pressure sensor and downstream pressure when the valve is fully open is the maximum differential pressure (ΔPₘₐₓ). ΔPₘₐₓ represents the maximum differential pressure that the flow controller is expected to experience during operation.

If the pressure sensors of the flow controller have a maximum pressure for which they are designed (a “maximum operating pressure”), the configuration program can account for this in the maximum differential pressure test by setting the maximum differential pressure to a level that will prevent the maximum operating pressure of a sensor from being exceeded. As an example, if an upstream pressure sensor has a maximum operating pressure of 30 psi, but opening the flow controller valve completely will cause the pressure at the upstream pressure sensor to exceed 30 psi, the configuration program can select a valve setting that causes the pressure at the upstream pressure sensor to be below 30 psi, say 28 psi. In this case, the configuration program will monitor the upstream pressure and open the valve until the upstream pressure is 28 psi or other predetermined pressure limit. The pressure differential when the upstream pressure is 28 psi or other pressure limit can be selected as the maximum pressure differential ΔPₘₐₓ. The flow device can further set a maximum flow rate for the flow device at a flow rate that is some percentage of ΔPₘₐₓ. For example, the configuration program can set the maximum flow rate to be the flow rate that occurs at 0.95 ΔP_{max.}

At step 1404, multiple empirical tests can be performed at different test ΔPs. According to one embodiment, each test ΔP can be located in a different region of the operational range of the flow device (e.g., near the fully closed position, near 0.5 ΔPₘₐₓ and near ΔPₘₐₓ), however any test ΔP can be used. For the sake of example, three test ΔP can be used (ΔPₜₑₛₜ₁, ΔPₜₑₛₜ₂, ΔPₜₑₛₜ₃). The flow device can be configured to produce a flow at each ΔPₜₑₛₜ for a specified test period of time (t₁, t₂, t₃), which may be the same or different for each test. As described in conjunction with FIG. 6, the flow rate for an empirical test can measured based on the amount of fluid dispensed (z) and the test period of time. Thus,

Xₑₘₚ₁=z₁/t₁ [EQN. 24]

Xₑₘₚ₂=z₂/t₂ [EQN. 25]

Xₑₘₚ₃=z₃/t₃ [EQN. 26]

At step 1406, the calibration program can solve for the coefficients of the flow curve using the empirical test data. Using the example of a second degree polynomial to represent the flow curve:

ΔPₜₑₛₜ₁=Axₑₘₚ₁²+Bxₑₘₚ₁+C [EQN. 27]

ΔPₜₑₛₜ₂=Axₑₘₚ₂²+Bxₑₘₚ₂+C [EQN. 28]

ΔPₜₑₛₜ₃=Axₑₘₚ₃²+Bxₑₘₚ₃+C [EQN. 29]

Solving for C using EQN 29:

C=ΔPₜₑₛₜ₃−Axₑₘₚ₃²−Bxₑₘₚ₃ [EQN. 30]

Solving for B by placing C of EQN. 30 into EQN. 28:

B=((ΔPₜₑₛₜ₂−ΔPₜₑₛₜ₃)/(xₑₘₚ₂−xₑₘₚ₃))−A(xₑₘₚ₂+xₑₘₚ₃) [EQN. 31]

Solving for A of EQN 26, using C of EQN. 29 and B of EQN. 30:

$$A = \frac{\begin{matrix}( Δ {P}_{test 1} - Δ {P}_{test 3} ) ( {x}_{emp 2} - {x}_{emp 3} ) - \\ ( Δ {P}_{test 2} - Δ {P}_{test 3} ) ( {x}_{emp 1} - {x}_{emp 3} )\end{matrix}}{( {x}_{emp 1} - {x}_{emp 3} ) ( {x}_{emp 2} - {x}_{emp 3} ) ( {x}_{emp 1} - {x}_{emp 2} )} \qquad [ EQN . 32 ]$$

At step 1408, the calibration program can save the new flow curve and, for example, the maximum flow rate for the device. The flow device can then use the flow curve for controlling flow. It should be noted that if a manufacturing flow curve is provided, the coefficients determined in equations 30-32, above, can be represented as correction factors F₁, F₂ and F₃ multiplied by the respective coefficients of the manufacturing flow curve (e.g., as shown in EQN. 8).

It should be noted that while a particular order for solving for the coefficients is described above, the coefficients can be determined using any methodology for solving for coefficients. It should be further noted that additional empirical tests can be performed to solve for higher order polynomials or increase accuracy. Furthermore, if the curve crosses through the zero intercept, only two empirical tests need to be performed as C=0.

A flow device can include a calibration program that allows for multiple methods of calibration. Thus, for example, a calibration program can be configured to calibrate a flow device using a single empirical test to derive a correction factor, multiple empirical tests to derive a second order polynomial as described in conjunction with FIG. 14, or viscosity correlation factors to calibrate a device based on the viscosity of a fluid. This can allow the flow control device to be calibrated by a user using the user's preferred method. For example, a user that does not have the time or inclination to run multiple empirical tests can employ a single empirical test to develop a correction factor, while another user may employ multiple empirical tests to develop a flow curve independent of the manufacturing flow curve.

Embodiments of the present invention allow a flow controller to be quickly recalibrated if the upstream and downstream process components change, the flow controller is reconfigured, tubing is changed or other changes to the process system or flow controller are made. This allows a process system to be easily reconfigured to accommodate various flow ranges. According to other embodiments, a flow device can be quickly calibrated simply using the kinematic viscosity or dynamic viscosity and density of a fluid.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

1-62. (canceled)

63. A method for calibrating a flow device comprising:
producing a flow having a test value for a variable indicative of a flow rate of a process fluid through the flow device;
determining an empirical flow rate of the process fluid based on amount of the process fluid dispensed by the flow device within a test period of time;
determining a calculated value for the variable indicative of the flow rate of the process fluid based on the empirical flow rate of the process fluid and a calibration curve generated using a test fluid;
determining a correction factor based on the test value and the calculated value; and
adjusting a flow curve for the process fluid based on the correction factor.

64. The method of claim 63, further comprising determining the correction factor based on multiple test values over multiple test periods of time.

65. The method of claim 64, further comprising determining at least one additional correction factor using at least one additional test value.

66. The method of claim 63, wherein the process fluid is different from the test fluid based on which the calibration curve is generated.

67. The method of claim 63, wherein the variable indicative of the flow rate is a pressure differential, time differential, or pressure at a sensor.

68. The method of claim 63, wherein the variable indicative of the flow rate is a pressure differential (ΔP) and wherein the test value (ΔPₜₑₛₜ) is approximately half of a maximum pressure differential (ΔPₘₐₓ) under which the flow device is expected to experience during operation.

69. The method of claim 68, wherein the correction factor (F) is the test value (ΔPₜₑₛₜ) divided by the calculated value (ΔP_{calc}) such that F=ΔPₜₑₛₜ/ΔP_{calc}.

70. The method of claim 69, wherein producing a corrected flow curve for the process fluid further comprises multiplying an n^{th} degree polynomial corresponding to the calibration curve by the correction factor.

71. The method of claim 70, further comprising storing corrected coefficients for the n^{th} degree polynomial at the flow device.

72. The method of claim 63, further comprising suggesting a sensitivity factor if the flow device has a response time that is different from a predefined time.

73. A computer readable medium carrying computer program instructions executable by a processor to:
determine one or more test values for a variable indicative of a flow rate of a process fluid through a flow device;
determine, corresponding to the one or more test values, one or more empirical flow rates of the process fluid through the flow device;
determine one or more calculated values for the variable indicative of the flow rate of the process fluid based on the one or more empirical flow rates and an n^{th} degree polynomial corresponding to a calibration curve generated using a test fluid; and
determining one or more correction factors based on the one or more calculated values and the one or more test values for the variable indicative of the flow rate of the process fluid.

74. The computer readable medium of claim 73, further comprises computer program instructions executable by the processor to store the one or more correction factors in a memory location accessible by the flow device.

75. The computer readable medium of claim 73, further comprises computer program instructions executable by the processor to:
load a set of coefficients for the n^{th} degree polynomial;
multiply each of the coefficients by at least one of the one or more correction factors to generate corrected coefficients; and
store the corrected coefficients in a memory location accessible by the flow device.

76. The computer readable medium of claim 73, wherein the variable indicative of the flow rate is a pressure differential, time differential, or pressure at a sensor.

77. The computer readable medium of claim 73, wherein the variable indicative of the flow rate is a pressure differential and wherein each of the one or more test values is less than a maximum pressure differential under which the flow device is expected to experience during operation.

78. The computer readable medium of claim 77, wherein each correction factor (F) of the one or more correction factors is a test value (ΔPₜₑₛₜ) of the one or more test values divided by a calculated value (ΔP_{calc}) of the one or more calculated values such that F=ΔPₜₑₛₜ/ΔP_{calc}.

79. The computer readable medium of claim 73, further comprises computer program instructions executable by the processor to determine at least one of the one or more test values based on sensor measurements.

80. The computer readable medium of claim 73, further comprises computer program instructions executable by the processor to determine a sensitivity factor if the flow device has a response time that is different from a predefined time.

81. The computer readable medium of claim 73, further comprises computer program instructions executable by the processor to save a maximum flow rate for the flow device.

82. A flow device comprising:
a flow path;
an upstream pressure sensor upstream of a flow restriction in the flow path;
a downstream pressure sensor downstream of the flow restriction in the flow path; and
a controller coupled to the upstream pressure sensor and the downstream pressure sensor to receive pressure measurements from the upstream and downstream pressure sensor, wherein the controller is operable to:
cause a valve to open for one or more test periods of time to produce a flow of fluid through the flow device to generate one or more test pressure differentials between the upstream pressure sensor and downstream pressure sensor;
determine one or more calculated pressure differentials based on at least one empirical flow rate for each test period of time and an n^{th} degree polynomial corresponding to a calibration flow curve; and
generate one or more correction factors using the one or more calculated pressure differentials and the one or more test pressure differentials.

83. The flow device of claim 82, wherein the controller is further operable to:
cause the valve to fully open; and
determine a maximum pressure differential for the flow device, wherein at least one of the one or more test pressure differentials is approximately half of the maximum pressure differential.

84. The flow device of claim 82, wherein the controller is further operable to multiply at least one of the one or more correction factors by a set of coefficients for the n^{th} degree polynomial to generate a set of corrected coefficients and store the corrected coefficients in a memory location.

85. The flow device of claim 84, wherein the controller is further operable to regulate fluid flow through the flow device using the corrected coefficients.

86. The flow device of claim 82, wherein the controller is further operable to determine the at least one empirical flow rate based on an input volume corresponding to each test period of time.

87. The flow device of claim 82, wherein the controller is further operable to:
determine a response time for the flow device; and
if the response time is different from a specified time, generate a new sensitivity factor.

88. A method for calibrating a flow device comprising:
loading a set of coefficients for an n^{th} degree polynomial corresponding to a calibration curve for a calibration fluid;
correcting the coefficients of the set of coefficients based on the viscosity of a process fluid to generate a set of corrected coefficients for a corrected n^{th} degree polynomial for the process fluid; and
storing the corrected coefficients in a memory location.

89. The method of claim 88, wherein correcting the coefficients of the set of coefficients based on the viscosity of a process fluid further comprises applying one or more viscosity correlation variables to each coefficient to generate a corresponding corrected coefficient.

90. The method of claim 88, wherein correcting the coefficients of the set of coefficients based on the viscosity of a process fluid to generate a corrected n^{th} degree polynomial for the process fluid further comprises:
for a first coefficient a, generating a first corrected coefficient a_{cor} according to a_{cor}=a*((v*D₁)+D₀), where a is a second order coefficient, v is a kinematic viscosity of the process fluid, D₁ is a first viscosity correlation variable, and D₀ is a second viscosity correlation variable; and
for a second coefficient b, generating a second corrected coefficient according to b_{cor}=b*(b*((v)^{0.5}*E₁)+E₀), where b is a first order coefficient, v is the kinematic viscosity of the process fluid, E₁ is a third viscosity correlation variable, and E₀ is a fourth viscosity correlation variable.

91. The method of claim 90, wherein D₁ and D₀ are derived from a curve fit of a set of second order coefficients divided by a versus the kinematic viscosity of the process fluid.

92. The method of claim 90, wherein E₁ and E₀ are derived from a curve fit of a set of first order coefficients divided by b versus the square root of the kinematic viscosity of the process fluid.

93. The method of claim 88, wherein correcting the coefficients of the set of coefficients based on the viscosity of a process fluid to generate a corrected n^{th} degree polynomial for the process fluid further comprises:
for a first coefficient a, generating a first corrected coefficient a_{cor} according to a_{cor}=a*(((μ/ρ)*D₁)+D₀), where a is a second order coefficient, μ is a dynamic viscosity of the process fluid, ρ is a density of the process fluid, D₁ is a first viscosity correlation variable, and D₀ is a second viscosity correlation variable; and
for a second coefficient b, generating a second corrected coefficient according to b_{cor}=b*(b*((μ/ρ)^{0.5}*E₁)+E₀), where b is a first order coefficient, μ is the dynamic viscosity of the process fluid, ρ is the density of the process fluid, E₁ is a third viscosity correlation variable, and E₀ is a fourth viscosity correlation variable.

94. The method of claim 88, wherein correcting the coefficients of the set of coefficients based on the viscosity of a process fluid to generate a corrected n^{th} degree polynomial for the process fluid further comprises:
for a first coefficient a, generating a first corrected coefficient a_{cor} according to a_{cor}=a*(((μ)*D₁)+D₀), where a is a second order coefficient, μ is a dynamic viscosity of the process fluid, D₁ is a first viscosity correlation variable, and D₀ is a second viscosity correlation variable; and
for a second coefficient b, generating a second corrected coefficient according to b_{cor}=b*(b*((μ)^{0.5}*E₁)+E₀), where b is a first order coefficient, μ is the dynamic viscosity of the process fluid E₁ is a third viscosity correlation variable, and E₀ is a fourth viscosity correlation variable.

95. A computer readable medium carrying computer program instructions implementing a method for calibrating a flow device, wherein the computer program instructions are executable by a processor to:
load a set of coefficients for an n^{th} degree polynomial corresponding to a calibration curve;
load a set of viscosity correlation variables;
receive an input indicating a viscosity of a process fluid;
correct the set of coefficients based on the set of viscosity correlation variables; and
store a set of corrected coefficients.

96. The computer readable medium of claim 95, wherein the input includes a dynamic viscosity (μ) of the process fluid and a density (ρ) of the process fluid.

97. The computer readable medium of claim 96, further comprises computer program instructions executable by the processor to:
for a first coefficient a, generate a first corrected coefficient a_{cor} according to a_{cor}=a*(((μ/ρ)*D₁)+D₀), where a is a second order coefficient, D₁ is a first viscosity correlation variable, and D₀ is a second viscosity correlation variable; and
for a second coefficient b, generate a second corrected coefficient according to b_{cor}=b*(b*((μ/ρ)^{0.5}*E₁)+E₀), where b is a first order coefficient, E₁ is a third viscosity correlation variable, and E₀ is a fourth viscosity correlation variable.

98. The computer readable medium of claim 95, wherein the input includes a kinematic viscosity (v) of the process fluid.

99. The computer readable medium of claim 98, further comprises computer program instructions executable by the processor to:
for a first coefficient a, generate a first corrected coefficient a_{cor} according to a_{cor}=a*(((v)*D₁)+D₀), where a is a second order coefficient, D₁ is a first viscosity correlation variable, and D₀ is a second viscosity correlation variable; and
for a second coefficient b, generate a second corrected coefficient according to b_{cor}=b*(b*((v)^{0.5}*E₁)+E₀), where b is a first order coefficient, E₁ is a third viscosity correlation variable, and E₀ is a fourth viscosity correlation variable.

100. The computer readable medium of claim 95, wherein the input includes a dynamic viscosity (μ) of the process fluid.

101. The computer readable medium of claim 100, further comprises computer program instructions executable by the processor to:
for a first coefficient a, generate a first corrected coefficient a_{cor} according to a_{cor}=a*(((μ)*D₁)+D₀), where a is a second order coefficient, D₁ is a first viscosity correlation variable, and D₀ is a second viscosity correlation variable; and
for a second coefficient b, generate a second corrected coefficient according to b_{cor}=b*(b*((μ)^{0.5}*E₁)+E₀), where b is a first order coefficient, E₁ is a third viscosity correlation variable, and E₀ is a fourth viscosity correlation variable.

102. A flow device having a controller comprising:
a computer readable medium storing a calibration program; and
a processor to access and execute the calibration program, wherein the controller is operable to:
load a set of coefficients for an n^{th} degree polynomial corresponding to a calibration curve for a calibration fluid;
correct the coefficients of the set of coefficients based on the viscosity of a process fluid to generate a set of corrected coefficients for a corrected n^{th} degree polynomial for the process fluid; and
store the corrected coefficients in a memory location.

103. The flow device of claim 102, wherein correcting the coefficients of the set of coefficients based on the viscosity of a process fluid further comprises applying one or more viscosity correlation variables to each coefficient to generate a corresponding corrected coefficient.

104. The flow device of claim 102, wherein the controller is further operable to:
for a first coefficient a, generate a first corrected coefficient a_{cor} according to a_{cor}=a*((v*D₁)+D₀), where a is a second order coefficient, v is a kinematic viscosity of the process fluid, D₁ is a first viscosity correlation variable, and D₀ is a second viscosity correlation variable; and
for a second coefficient b, generate a second corrected coefficient according to b_{cor}=b*(b*((v)^{0.5}*E₁)+E₀), where b is a first order coefficient, v is the kinematic viscosity of the process fluid, E₁ is a third viscosity correlation variable, and E₀ is a fourth viscosity correlation variable.

105. The flow controller of claim 102, wherein the controller is further operable to:
for a first coefficient a, generate a first corrected coefficient a_{cor} according to a_{cor}=a*(((μ/ρ)*D₁)+D₀), where a is a second order coefficient, μ is a dynamic viscosity of the process fluid, ρ is a density of the process fluid, D₁ is a first viscosity correlation variable, and D₀ is a second viscosity correlation variable; and
for a second coefficient b, generate a second corrected coefficient according to b_{cor}=b*(b*((μ/ρ)^{0.5}*E₁)+E₀), where b is a first order coefficient, μ is the dynamic viscosity of the process fluid, ρ is the density of the process fluid, E₁ is a third viscosity correlation variable, and E₀ is a fourth viscosity correlation variable.

106. The flow controller of claim 102, wherein the controller is further operable to:
for a first coefficient a, generate a first corrected coefficient a_{cor} according to a_{cor}=a*(((μ)*D₁)+D₀), where a is a second order coefficient, μ is a dynamic viscosity of the process fluid, D₁ is a first viscosity correlation variable, and D₀ is a second viscosity correlation variable; and
for a second coefficient b, generate a second corrected coefficient according to b_{cor}=b*(b*((μ)^{0.5}*E₁)+E₀), where b is a first order coefficient, μ is the dynamic viscosity of the process fluid, E₁ is a third viscosity correlation variable, and E₀ is a fourth viscosity correlation variable.

107. A method for calibrating a flow device, comprising:
determining a maximum value for a variable indicative of a differential pressure, differential time, or pressure under which the flow device is expected to experience during operation;
performing multiple empirical tests at test values, each of which is less than the maximum value for the variable indicative of a differential pressure, differential time, or pressure;
determining a set of coefficients for an n^{th} degree polynomial using the test values and empirical flow rates; and
storing the set of coefficients.

108. The method of claim 107, wherein the n^{th} degree polynomial is a second degree polynomial.

109. The method of claim 107, wherein a manufacturing flow curve is accessible by the flow device, further comprising applying the set of coefficients as correction factors to the manufacturing flow curve.

110. The method of claim 107, wherein each of the set of test values is located in a different region of an operational range of the flow device.

111. A computer readable medium carrying computer program instructions implementing a method for calibrating a flow device, wherein the computer program instructions are executable by a processor to:
determine a maximum value for a variable indicative of a differential pressure, differential time, or pressure under which the flow device is expected to experience during operation;
perform multiple empirical tests at test values, each of which is less than the maximum value for the variable indicative of a differential pressure, differential time, or pressure;
determine a set of coefficients for an n^{th} degree polynomial using the test values and empirical flow rates; and
store the set of coefficients.

112. The computer readable medium of claim 111, wherein the n^{th} degree polynomial is a second degree polynomial.

113. The computer readable medium of claim 111, further comprises computer program instructions executable by the processor to obtain a manufacturing flow curve for the flow device and apply the set of coefficients as correction factors to the manufacturing flow curve.

114. The computer readable medium of claim 111, further comprises computer program instructions executable by the processor to apply the set of coefficients in regulating flow of fluid through the flow device.

115. A flow device comprising:
a flow path;
an upstream pressure sensor upstream of a flow restriction in the flow path;
a downstream pressure sensor downstream of the flow restriction in the flow path;
a controller coupled to the upstream pressure sensor and the downstream pressure sensor to receive pressure measurements from the upstream and downstream pressure sensor, wherein the controller is operable to:
cause a valve to open for a set of test periods of time to produce a flow of fluid through the flow device to generate a set of test pressure differentials between the upstream pressure sensor and downstream pressure sensor;
determine an empirical flow rate for each test pressure differential; and
determine a set of coefficients for an n^{th} degree polynomial using the set of test pressure differentials and empirical flow rates.

116. The flow device of claim 115, wherein the controller is further operable to cause the valve to open for at least three test periods of time to generate at least two test pressure differentials.

117. The flow device of claim 115, wherein the controller is further operable to apply the set of coefficients in regulating flow of fluid through the flow device.
